(19) United States
(12) Patent Application Publication
(10) Pub. No.: US 2008/0122374 A1
(43) Pub. Date: May 29, 2008

(54) PLASMA DISPLAY DEVICE AND DRIVING METHOD THEREOF

(75) Inventor: JAEYOUNG YEO, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/940,424

(22) Filed: Nov. 15, 2007

(30) Foreign Application Priority Data
Nov. 27, 2006 (KR) 2006-117890

(51) Int. Cl. G09G 3/10; G09G 5/10

(52) U.S. Cl. 315/169.4; 345/690

(57) ABSTRACT

A plasma display device and a driving method thereof. The plasma display device includes an inductor coupled to a plurality of electrodes; a first transistor coupled between a contact of the plurality of electrodes and the inductor, and a first power supply to supply a first voltage; a second transistor coupled between a contact, which is coupled with the plurality of electrodes and the inductor, and a second power supply to supply a second voltage that is lower than the first voltage; a third transistor coupled between a third power supply, to supply a third voltage, and the inductor; a fourth transistor coupled in parallel with the third transistor; and a discharge part coupled between the second power supply and the plurality of electrodes, to form a discharge path for discharging the voltage stored in the inductor.

### CROSS-REFERENCE TO RELATED APPLICATIONS

This application claims to the benefit of Korean Application No. 2006-117890, filed Nov. 27, 2006, in the Korean Intellectual Property Office, the disclosure of which is incorporated herein by reference.

### BACKGROUND OF THE INVENTION

1. Field of the Invention

Aspects of the present invention relate to a plasma display device and a driving method thereof.

2. Description of the Related Art

Generally, a plasma display device is a display device having a plasma display panel (hereafter, referred to as “PDP”) for displaying text or an image, using plasma generated by a gas discharge. The PDP includes a plurality of driving circuit portions that are driven to produce a moving picture.

The PDP of the plasma display device is driven by dividing one frame into a plurality of sub-fields that each have a weight value. Each sub-field is divided into a reset period, an address period, and a sustain period. Light emitting cells and non-light emitting cells are selected during the address periods, and a sustain discharge is applied to the addressed light emitting cells, so as to actually display an image, during the sustain periods. Further, a gray level is displayed, according to a combination of the weight values of the sub-fields.

Electrodes, to which the sustain pulses are applied during the sustain periods, are operated under a capacitive load. To apply a sustain pulse, to an electrode in a sustain discharge circuit, a reactive power is provided for a charge injection, in addition to providing a non-reactive power for a sustain discharge. An energy recovery circuit that recovers and reuses the reactive power is used in the sustain discharge circuit.

The energy recovery circuit may use an inductor to boost an input voltage up to a high voltage for use in a sustain pulse. However, the voltage is stored in the inductor during a falling period of the sustain pulse, when the voltage of the sustain pulse is decreasing. The voltage stored in the inductor is reduced to a ground voltage, through a transistor coupled to a ground terminal. Accordingly, the transistor coupled with the ground terminal performs a hard switching, as the inductor is charged during the falling period of the sustain pulse. Recently, the energy recovery rate has been increased, in order to reduce the amount of reactive power used, by increasing the voltage stored in the inductor, and by increasing the amount of hard switching performed by the transistor coupled to the ground terminal. Accordingly, the power consumption and heat stress of the transistor is increased, thereby frequently causing the transistor to malfunction and electromagnetic interference (EMI) to occur.

### SUMMARY OF THE INVENTION

Accordingly, aspects of the present invention provide a plasma display device and a driving method thereof, which can minimize the hard switching of a transistor.

According to aspects of the present invention, there is provided a plasma display device, which includes: an inductor coupled to a plurality of first electrodes; a first transistor coupled between a contact of the plurality of first electrodes and the inductor, and a first power supply to supply a first voltage; a second transistor coupled between a contact of the plurality of first electrodes and the inductor, and a second power supply to supply a second voltage that is lower than the first voltage; a third transistor coupled between a third power supply, to supply a third voltage, and the inductor; a fourth transistor coupled in parallel with the third transistor; and a discharge part coupled between the second power supply and the plurality of first electrodes, to form a discharge path for discharging a voltage stored in the inductor.

The discharge part may further include a fifth transistor, coupled to the plurality of first electrodes, to control the flow of the voltage stored in the inductor; a capacitor coupled between the fifth transistor and the second power supply; and a resistor coupled in parallel with the capacitor. The fifth transistor may be turned on before the second transistor is turned on.

A voltage of the first electrode is increased when the third transistor is turned on. The first voltage is applied to the first electrode when the first transistor is turned on. A voltage of the first electrode is decreased when the fourth transistor is turned on. A voltage stored in the inductor is discharged when the fifth transistor is turned on. In addition, the second voltage is applied to the first electrode when the second transistor is turned on.

The third power supply may further include a capacitor having an anode coupled to a contact of the third and fourth transistors. The third power supply may further include a first diode, coupled between the inductor and the third transistor, to control the direction of a current, so as to increase the voltage of the first electrode. The third power supply can include a second diode, coupled between the inductor and the fourth transistor, to control the direction of a current, so as to decrease the voltage of the first electrode. The second voltage may be a ground voltage.

According to aspects of the present invention, there is provided a driving method of a plasma display device, which includes: increasing a voltage of the plurality of first electrodes using an inductor; applying a first voltage of a first power supply to the plurality of first electrodes; reducing the voltage of the plurality of first electrodes using the inductor; discharging a voltage stored in the inductor, using a discharge part, coupled between a second power supply to supply a second voltage that is lower than the first voltage, and the plurality of first electrodes; and applying the second voltage to the plurality of first electrodes.

The operation of discharging the voltage stored in the inductor may include: turning on a transistor coupled between contacts of the inductor and the plurality of first electrodes; charging a capacitor using a voltage stored in the inductor that was supplied through the transistor; and consuming the voltage stored in the capacitor through a discharge resistor.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a plasma display device, according to aspects of the present invention;

FIG. 2 is a diagram illustrating the arrangement of sub-fields, according to aspects of the present invention;

FIG. 3 is a diagram illustrating a driving waveform of a plasma display device, according to aspects of the present invention;

FIG. 4 is a circuit diagram illustrating a sustain pulse generating circuit, to generate a sustain pulse, as shown in FIG. 3;

FIG. 5 is a diagram illustrating a sustain pulse, shown in FIG. 3, divided into a plurality of intervals and the timing of a transistor, according to the intervals; and

FIGS. 6A to 6E are diagrams illustrating a current path in respective intervals, as shown in FIG. 5.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

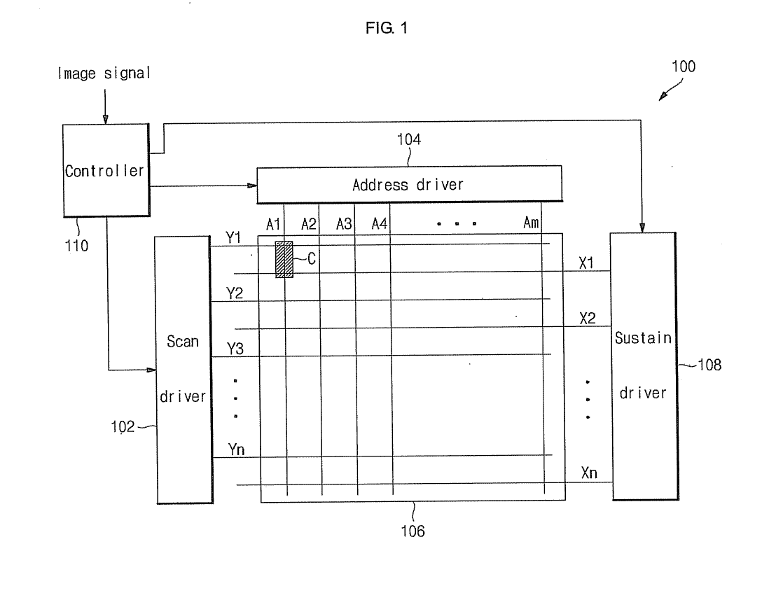

FIG. 1 is a block diagram illustrating a plasma display device 100, according to aspects of the present invention. Referring to FIG. 1, the plasma display device includes: a plasma display panel (PDP) 106 to display an image; an address driver 104 to supply data to a plurality of address electrodes (A1 to Am) of the PDP 106; a scan driver 102 to drive a plurality of scan electrodes (Y1 to Yn) (or first electrodes), a sustain driver 108 to drive a plurality of sustain electrodes (X1 to Xn), and a controller 110 to control the drivers 102, 104, and 108.

The PDP 106 displays an image using a plurality of discharging cells (C) arranged in the form of a matrix. The PDP 106 includes the plurality of address electrodes (A1 to Am), which extend in a column direction, the plurality of scan electrodes (Y1 to Yn), which extend in a row direction, and the plurality of sustain electrodes (X1 to Xn), which extend in the row direction and are paired with respective scan electrodes (Y1 to Yn). The address electrodes (A1 to Am) intersect with the scan electrodes (Y1 to Yn) and the sustain electrodes (X1 to Xn).

The controller 110 is driven by dividing one frame into a plurality of sub-fields. The sub-fields each include a reset period, an address period, and a sustain period, that correspond to operational changes over time. The controller 110 receives a vertical/horizontal synchronizing signal and generates an address control signal, a scan control signal, and a sustain control signal for the respective drivers 102, 104, and 108. The generated control signals are supplied to relevant drivers 102, 104, and 108, so that the controller 110 controls the drivers 102, 104, and 108.

The address driver 104 supplies a data signal to the respective address electrodes (A1 to Am), to select cells to be discharged, in response to the address control signal output from the controller 110. The scan driver 102 applies a driving voltage to the scan electrodes (Y1 to Yn), in response to the scan control signal output from the controller 110. The sustain driver 108 applies a driving voltage to the sustain electrodes (X1 to Xn), in response to a sustain control signal output from the controller 110.

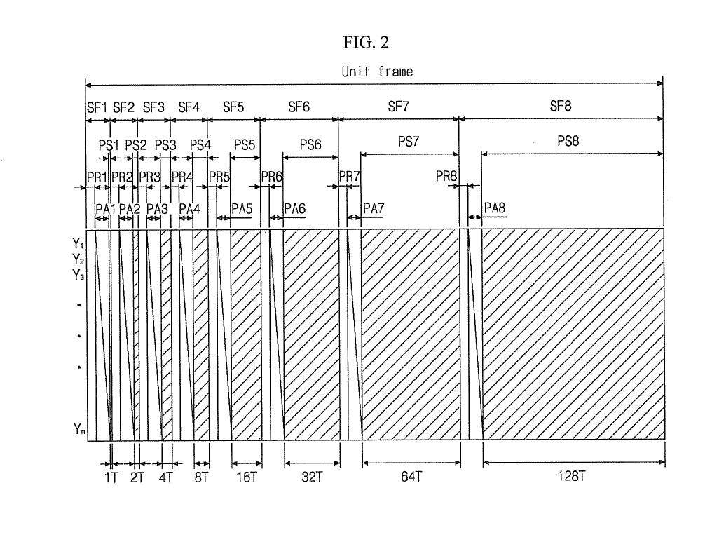

FIG. 2 is a diagram illustrating a unit frame to display an image on a plasma display device, according to aspects of the present invention. Referring to FIG. 2, the unit frame is divided into 8 sub-fields (SF1 to SF8), to display a time-division gray level. The sub-fields are divided into reset periods (PR1 to PR8), address periods (PA1 to PA8), and sustain periods (PS1 to PS8), respectively.

The luminance of the plasma display panel is in proportion to the length of the sustain periods (PS1 to PS8) of the unit frame. The combined length of the sustain periods (PS1 to PS8) is 255T (T, prescribed as a unit time). In this case, for a sustain period (PSn) of an nth sub-field (SFn), a time relevant to 2ⁿ is set. Accordingly, 256 different gray levels, including a 0 gray level not displayed during any sub-field, may be displayed.

Weight values, relating to gray levels of the sub-fields, are respectively assigned from the first sub-field (SF1) to the eighth sub-field (SF8), such as, 1T, 2T, . . . , and 128T, however, this is merely an example, and the present teaching are not limited thereto. In other words, the number of sub-fields of the unit frame may be more than or less than 8, and the assignment of the weight values to the respective sub-fields may be changed, according to various design specifications.

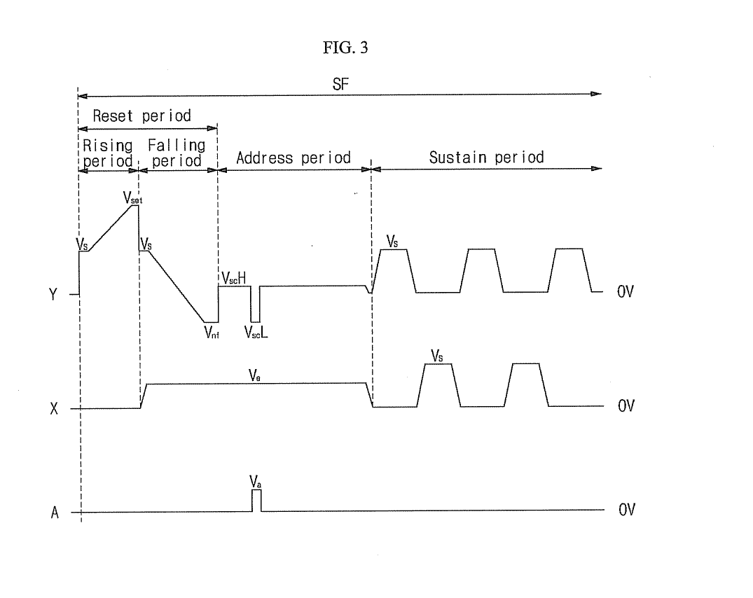

FIG. 3 is a detailed diagram illustrating a driving waveform supplied during a reset period, an address period, and a sustain period, as shown in FIG. 2. Referring to FIG. 3, the PDP 106 displays a predetermined image by performing a reset period, an address period, and a sustain period, in order, generally during one sub-field (SF).

During a rising period of the reset period, a voltage of a Y electrode is gradually increased from a voltage Vs to a voltage Vset. An X electrode is maintained at a reference voltage 0V. A weak discharge, between the Y and X electrodes and between the Y and A electrodes, respectively, occurs while the voltage of the Y electrode is increasing. A negative wall charge is formed in the Y electrode, and a positive wall charge is formed in the X and A electrodes.

During a falling period of the reset period, a voltage of the Y electrode is gradually decreased from the voltage Vs to a voltage Vnf. A voltage Ve is applied to the X electrode. A weak discharge occurs between the Y and X electrodes and between the Y and A electrodes, while the voltage of the Y electrode is decreased. A negative wall charge is maintained in the Y electrode, and the positive wall charges are erased from the X and A electrodes, so that discharge cells are initialized. Generally, the value of the voltage | Vnf-Ve | is set to approximate a firing voltage between the Y and X electrodes. A wall voltage between the Y and X electrodes is nearly 0V, to prevent misfiring of the discharge cells, which have not been discharged during the address period, to allow such cells to be discharged during the sustain period.

During an address period, one or more discharge cells can be selected for subsequent emission, by applying various voltages thereto. For example, to select the discharge cell C, during the address period, the voltage Ve is applied to the X1 electrode, a scan pulse with a voltage VscL is sequentially applied to the Y1 electrode. A Voltage Va is applied to the A1 electrode, passing through the selected discharge cell C. Then, an address discharge occurs between the A1 electrode and the Y1 electrode and between the Y1 and the X electrode, so that a positive wall charge is formed in the Y1 electrode, and a negative wall charge is respectively formed in the A1 and X1 electrodes. The voltage VscL may be set as the same as or less than the voltage Vnf. In addition, in the Y electrodes, to which the voltage VscL is not applied, the voltage VscH, which is higher than the voltage VscL, is applied, and a reference voltage (0V in FIG. 3) is applied to the A electrodes of unselected discharge cells.

In order to select cells during the address period, the scan driver 102 selects a Y electrode, to which a scan pulse with the voltage VscL will be applied, among the Y electrodes (Y1 to Yn). For example, in a case where a single cell is driven, a Y electrode may be selected in an order arranged in a vertical direction. Once a Y electrode is selected, the address driver 104 selects a discharge cell to be turned on, among discharge cells including the selected Y electrode. In other words, the address driver 104 selects a cell, to which an address pulse of a voltage Va will be applied, among the A electrodes (A1 to Am).

During the sustain period, a sustain pulse, having a high voltage (the voltage Vs in FIG. 3) and a low voltage (0V in FIG. 3), is alternately applied to the Y and X electrodes, so that a sustain discharge occurs between the Y and X electrodes of the selected discharge cells. The number of the sustain pulses is selected according to the weight value of the respective sub-fields.

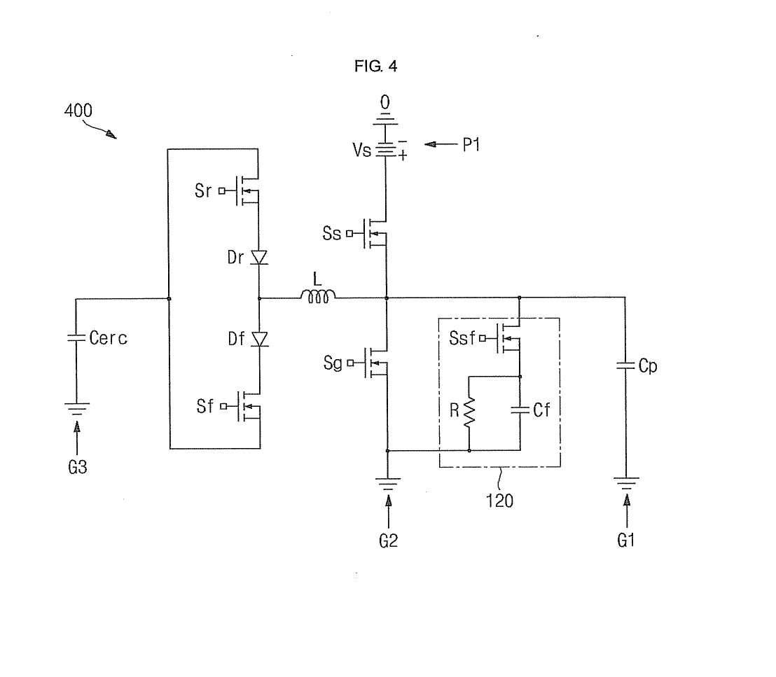

FIG. 4 is a circuit diagram illustrating a sustain pulse generating circuit 400, to generate a sustain pulse as shown in FIG. 3. A panel capacitor (Cp), in FIG. 4, equivalently illustrates a capacitance component between X and Y electrodes. For convenience, the X electrode of the panel capacitor (Cp) is indicated to be coupled to a ground terminal G1, but the X electrode is actually coupled to the sustain electrode driver 108.

Throughout this specification and in the following claims, when it is described that an element is “coupled” to another element, the element may be “directly coupled” to the other element or “electrically coupled” to the other element through a third element. For example, the element may be connected to the other element by a wire or other electrical connection. Throughout this specification and in the following claims, when it is described that a first element is “coupled between” second and third elements, the first element may have a first contact, which is coupled to the second element, and the first element may have a second contact which is coupled to the third element. In some circumstances, a first element “coupled between” second and third elements can refer to a series connection, with the first element being coupled in series between the second and third elements. A “contact”, as used herein, refers to an electrical connection or node. For example, a transistor coupled to a contact, which is coupled to an electrode and a capacitor, can refer to an connection between a wire connected to the transistor and a wire connected to the electrode and capacitor. Either wire can continue on and connect to other elements.

The sustain pulse generating circuit 400, as shown in FIG. 4, includes a recovery capacitor (Cerc), an inductor (L), transistors (Sr, Sf, Ss, and Sg), diodes (Dr and Df), and a discharge part 120. Herein, the transistor Ss is referred to as a first transistor, the transistor Sg is referred to as a second transistor, the transistor Sr is referred to as a third transistor, the transistor Sf is referred to as a fourth transistor, the diode Dr is referred to as a first diode, and the diode Df is referred to as a second diode.

The recovery capacitor (Cerc) is coupled to the panel capacitor (Cp) and is to supply or recover predetermined charges. A cathode of the recovery capacitor (Cerc) is coupled to a ground terminal G3, and an anode of the recovery capacitor (Cerc) is coupled to a contact between the third and fourth transistors (Sr and Sf). The recovery capacitor (Cerc) can be referred to as a third power supply.

One terminal of the inductor (L) is coupled to a contact between the first and second diodes (Dr and Df), and the other terminal is coupled to the panel capacitor (Cp). The inductor (L) and the panel capacitor (Cp) allow a resonance to be generated therebetween.

The first transistor (Ss) includes: a drain coupled to a first power supply (P1) to supply a first voltage, i.e., a Vs voltage; a source coupled to the panel capacitor (Cp); and a gate coupled to a control signal terminal (not shown), to which a low or high level control signal is input. The second transistor (Sg) includes: a drain coupled to the panel capacitor (Cp); a source coupled to a second power supply, i.e., a ground terminal G2 to supply a second voltage, i.e., a ground voltage; and a gate coupled to a control signal terminal (not shown), to which a low or high level control signal is input. The third transistor (Sr) includes a drain coupled to the third power supply, i.e., the recovery capacitor (Cerc); a source coupled to the first diode (Dr); and a gate coupled to a control signal terminal (not shown), to which a low or high level control signal is input. The fourth transistor (Sf) includes: a drain coupled to the second diode (Df); a source coupled to the recovery capacitor (Cerc); and a gate coupled to a control signal terminal (not shown), to which a low or high level control signal is input.

The first and second diodes (Dr and Df) are disposed to cut-off a current flow from a body diode (not shown), coupled to the third and fourth transistors (Sr and Sf). An anode of the first diode (Dr) is coupled to the third transistor (Sr), and a cathode of the first diode (Dr) is coupled to the inductor (L). An anode of the second diode (Df) is coupled to the inductor (L), and a cathode of the second diode (Df) is coupled to the fourth transistor (Sf). In addition to the first and second diodes (Dr and Df), a diode (not shown) can be coupled between the first power supply P1, which is to supply the Vs voltage, and the inductor (L) to clamp a voltage of the other terminal of the inductor (L) to the Vs voltage. A diode (not shown) can be coupled between the ground terminal G2 and the inductor (L), to clamp a voltage of the other terminal of the inductor (L) to 0V.

The discharge part 120 includes a transistor (Ssf), a bypass capacitor (Cf) and a discharge resistor (R). The transistor Ssf is referred to as a fifth transistor. The fifth transistor (Ssf) includes: a drain coupled to the panel capacitor (Cp); a source coupled to a contact of the discharge resistor (R) and to a capacitor, i.e., the bypass capacitor (Cf); and a gate coupled to a control signal terminal (not shown), from which a low or high level control signal is input. The fifth transistor (Ssf) is switched to supply a voltage stored in the inductor (L) to the bypass capacitor (Cf), before the second transistor (Sg), is turned on. Likewise, the voltage stored in the inductor (L), through the fifth transistor (Ssf), is minimized, so that the hard switching of the second transistor (Sg) may be minimized.

The bypass capacitor (Cf) bypasses a high-frequency component of the voltage charge in the inductor (L) through the ground terminal G2, due to a decrease of impedance, if the high-frequency component is input through the fifth transistor (Ssf). Further, if a low-frequency component of the voltage stored in the inductor (L) is input through the fifth transistor (Ssf), the bypass capacitor (Cf) stores the low-frequency component, due to the increase of impedance. One terminal of the bypass capacitor (Cf) is coupled to the ground terminal G2, and the other is coupled to the fifth transistor (Ssf).

The discharge resistor (R) consumes the voltage of the inductor (L), stored in the bypass capacitor (Cf), through the ground terminal G2, if the fifth transistor (Ssf) is turned off. The discharge resistor (R) is coupled in parallel with the bypass capacitor (Cf).

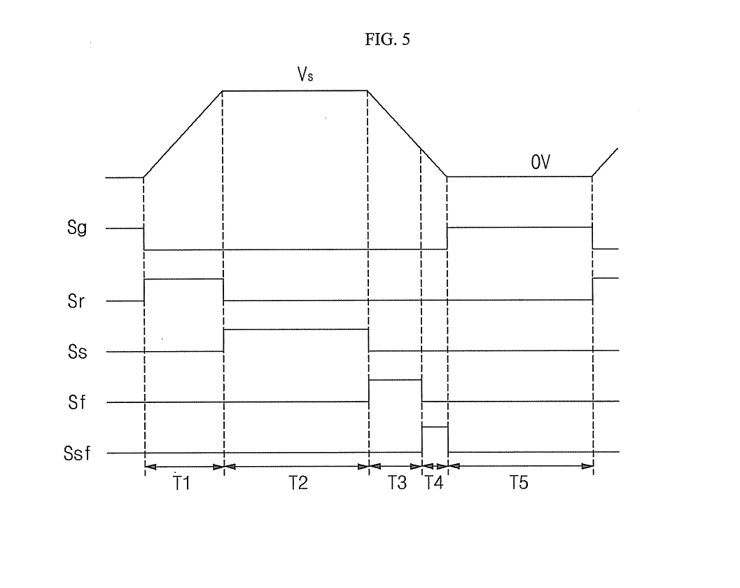

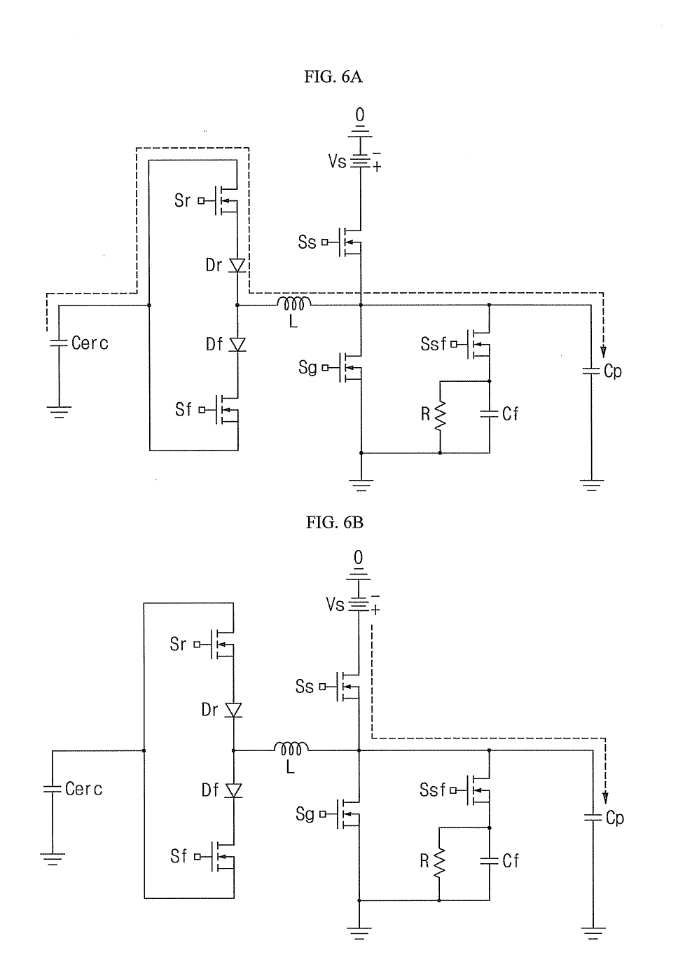

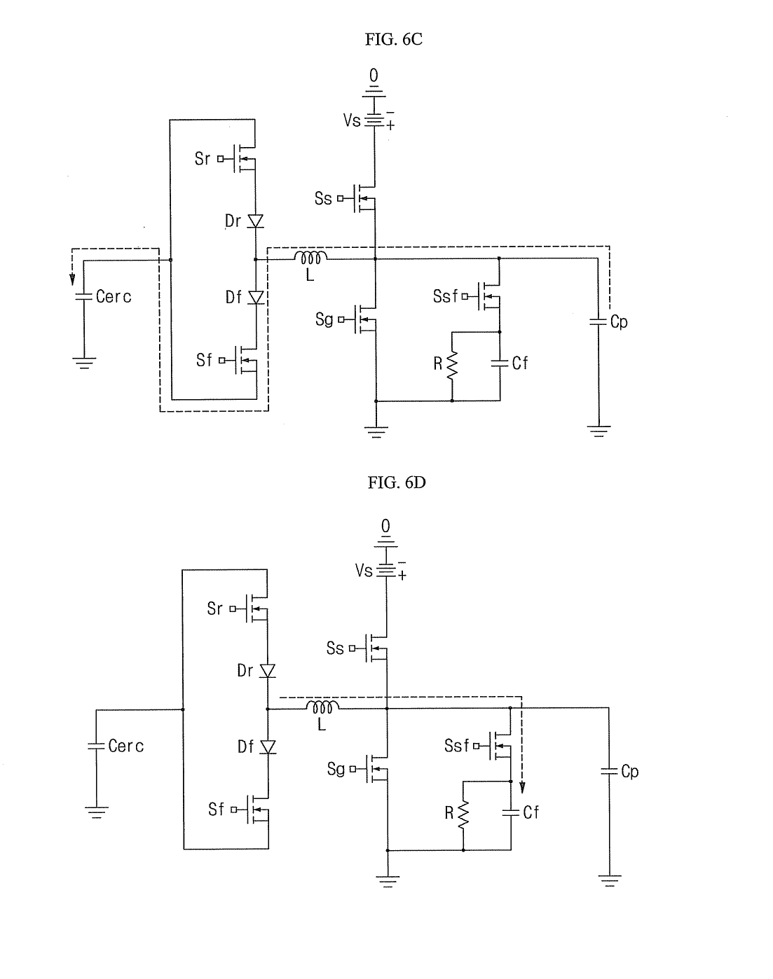

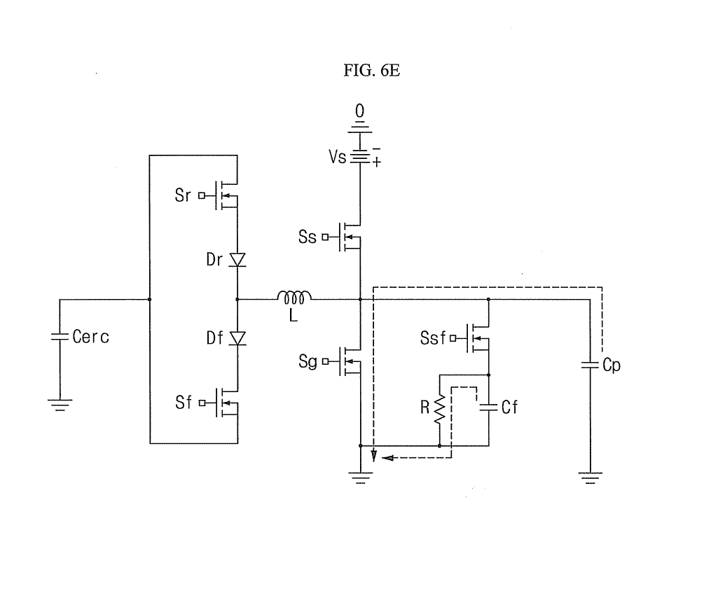

FIG. 5 is a diagram illustrating an operation timing for a sustain period, using the circuit as shown in FIG. 4. FIGS. 6A to 6E are diagrams illustrating current paths for respective periods, as shown in FIG. 5.

Referring to FIG. 5, during an interval T1, the third transistor (Sr) is turned on when a high level control signal is applied to the third transistor (Sr). Then, referring to FIG. 6A, a current path is formed from the recovery capacitor (Cerc), through the third transistor (Sr), the first diode (Dr), the inductor (L), and to the panel capacitor (Cp), so that a resonance occurs between the inductor (L) and the panel capacitor (Cp). The current stored in the recovery capacitor (Cerc) is moved to and is stored in the panel capacitor (Cp), by the above resonance. The voltage of a Y electrode of the panel capacitor (Cp) is gradually increased from 0V.

During an interval T2, a low level control signal is applied to the third transistor (Sr), and a high level control signal is applied to the first transistor (Ss), so that the first transistor (Ss) is turned on. Then, referring to FIG. 6B, a current path is formed from a Vs power supply, through the first transistor (Ss), and to the panel capacitor (Cp). Accordingly, the Vs voltage is applied to the Y electrode of the panel capacitor (Cp), through the first transistor (Ss).

During an interval T3, a low level control signal is applied to the first transistor (Ss), and a high level control signal is applied to the fourth transistor (Sf), so that the fourth transistor (Sf) is turned on. Then, referring to FIG. 6C, a current path is formed from the panel capacitor (Cp), through the inductor (L), the second diode (Df), the fourth transistor (Sf), and to the recovery capacitor (Cerc), so that a resonance occurs between the inductor (L) and the panel capacitor (Cp). The current stored in the panel capacitor (Cp) is moved to and is stored in the recovery capacitor (Cerc), by the above resonance, and the voltage of the Y electrode, of the panel capacitor (Cp), is gradually decreased from the Vs voltage.

During an interval T4, a low level control signal is applied to the fourth transistor (Sf), and a high level control signal is applied to the fifth transistor (Ssf), so that the fifth transistor (Ssf) is turned on. At this time, a turn-on period of the fifth transistor (Ssf) is shorter than that of the fourth transistor (Sf). Then, referring to FIG. 6D, a current path is formed from the inductor (L), through the fifth transistor (Ssf), and to the bypass capacitor (Cf). The voltage stored in the inductor (L) is applied to the bypass capacitor (Cf) through the fifth transistor (Ssf). In this case, a high-frequency component of about 30 to 100 MHz, included in the voltage stored in the inductor (L), is applied to the bypass capacitor (Cf), the bypass capacitor (Cf) maintains in a short status, due to a decrease of impedance. Accordingly, the voltage stored in the inductor (L) is induced at the second voltage, i.e., a ground voltage, through the fifth transistor (Ssf) and the bypass capacitor (Cf). Further, a frequency component of less than 30 MHz, included in the voltage stored in the inductor (L), is applied to the bypass capacitor (Cf), and the bypass capacitor (Cf) charges a voltage from the inductor (L), due to the increase of impedance.

During an interval T5, a low level control signal is applied to the fifth transistor (Ssf), and a high level control signal level is applied to the second transistor (Sg), so that the second transistor (Sg) is turned on. Then, referring to FIG. 6E, a current path is formed from the panel capacitor (Cp), through the second transistor (Sg) and to the ground terminal G3. A ground voltage is then applied to the Y electrode of the panel capacitor (Cp). The voltage stored in the bypass capacitor is induced at the ground voltage, through the discharge resistor (R).

Likewise, the plasma display device 100, according to aspects of the present invention, allows the second transistor (Sg), which is coupled to a ground terminal G2, to be turned on after the voltage stored in the inductor (L) has been reduced through the discharge part 120, during the interval T3. Accordingly, the hard switching of the second transistor (Sg) is minimized, the associated EMI is reduced, and heat generated from the second transistor (Sg) is decreased about 5 to 10 degrees, in comparison with the related art. As described above, the plasma display device according to aspects of present invention minimizes the hard switching of a transistor coupled to a ground, thereby reducing the heat stress of the transistor and the electro magnetic interference (EMI) therefrom.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device including a plurality of electrodes, comprising:
an inductor coupled to a plurality of electrodes;
a first transistor coupled between a contact, which is coupled to the plurality of electrodes and the inductor, and a first power supply to supply a first voltage;
a second transistor coupled between a contact, which is coupled to the plurality of electrodes and the inductor, and a second power supply to supply a second voltage that is lower than the first voltage;
a third transistor coupled between the inductor and a third power supply to supply a third voltage;
a fourth transistor coupled in parallel with the third transistor; and
a discharge part, coupled between the second power supply and the plurality of electrodes, to form a discharge path to discharge a voltage stored in the inductor.

2. The plasma display device of claim 1, wherein the discharge part comprises:
a fifth transistor coupled to the plurality of electrodes, to control a flow of the voltage stored in the inductor;
a first capacitor coupled between the fifth transistor and the second power supply; and
a resistor coupled in parallel with the first capacitor.

3. The plasma display device of claim 2, wherein the fifth transistor is turned on before the second transistor is turned on.

4. The plasma display device of claim 3, wherein:
a voltage of the plurality of electrodes is increased when the third transistor is turned on;
the first voltage is applied to the plurality of electrodes when the first transistor is turned on;
the voltage of the plurality of electrodes is decreased when the fourth transistor is turned on;
a voltage stored in the inductor is discharged when the fifth transistor is turned on; and
the second voltage is applied to the plurality of electrodes when the second transistor is turned on.

5. The plasma display device of claim 1, wherein the third power supply comprises a capacitor having an anode coupled to a contact that is coupled to the third and fourth transistors.

6. The plasma display device of claim 1, wherein the plasma display device further comprises:
a first diode, coupled between the inductor and the third transistor, to control a direction of a current to increase a voltage of the plurality of electrodes; and
a second diode, coupled between the inductor and the fourth transistor, to control a direction of a current to decrease a voltage of the plurality of electrodes.

7. The plasma display device of claim 6, wherein the second voltage is a ground voltage.

8. A driving method of a plasma display device including a plurality of electrodes, the method comprising:
increasing a voltage applied to the plurality of electrodes, using an inductor;
applying a first voltage from a first power supply to the plurality of electrodes;
decreasing a voltage of the plurality of electrodes, using the-inductor;
discharging a voltage stored in the inductor using a discharge part coupled between a second power supply, to supply a second voltage that is lower than the first voltage, and the plurality of electrodes; and
applying the second voltage to the plurality of electrodes.

9. The driving method of the plasma display device of claim 8, wherein the discharging of the voltage stored in the inductor comprises:
turning on a transistor coupled between the inductor and a contact of the plurality of first electrodes;
moving a voltage stored in the inductor, through the transistor, to the capacitor; and
consuming the voltage stored in the capacitor, using a discharge resistor.

10. The driving method of the plasma display device of claim 8, wherein the second voltage is a ground voltage.

11. A driving method of a plasma display device, comprising:
applying an increasing voltage from a recovery capacitor, through an inductor, to a panel capacitor connected to a plurality of electrodes;
applying a first voltage from a power supply to the panel capacitor;
moving a charge from the panel capacitor, through the inductor, to a recovery capacitor;
discharging the inductor through a discharge part connected to a ground terminal; and
discharging the panel capacitor to the ground terminal.

12. The driving method of claim 11, wherein the moving of the charge from the panel capacitor comprises creating a resonance between the panel capacitor and the inductor.

13. The driving method of claim 11, wherein the applying of the increasing voltage comprises creating a resonance between the recover capacitor and the inductor.

14. The driving method of claim 11, wherein:
the discharge part comprises a resistor and a bypass capacitor coupled in parallel to a transistor and the ground terminal, and the transistor is coupled to a contact that is coupled to the inductor and the panel capacitor; and
the discharging of the inductor comprises:
turning on the transistor;
charging the bypass capacitor; and
discharging the bypass capacitor through the resistor to the ground terminal.

15. The driving method of claim 14, wherein the bypass capacitor stores a low frequency component of a voltage discharged from the inductor.

16. The plasma display device of claim 1, wherein the electrodes are Y electrodes.

17. The driving method of the plasma display device of claim 8, wherein the electrodes are Y electrodes.
